(19) United States
(12) Patent Application Publication
(10) Pub. No.: US 2003/0074091 A1
(43) Pub. Date: Apr. 17, 2003

(54) User interface method and apparatus for appliance connected with host system

(75) Inventor: Dong Hyun Kim, Taegu (KR)

Correspondence Address: FLESHNER & KIM, LLP, 14500 AVION PARKWAY, SUITE 125, CHANTILLY, VA, 20151, US

(73) Assignee: LG Electronics Inc.

(21) Appl. No.: 10/268,671

(22) Filed: Oct. 11, 2002

(30) Foreign Application Priority Data
Oct. 12, 2001 (KR) 2001-062879

(51) Int. Cl. G05B 15/00

(52) U.S. Cl. 700/83

(57) ABSTRACT

A user interface method and apparatus for an appliance connected with a host system is disclosed. According to the user interface method, the host computer displays menus having a structure identical with a structure of menus implemented in the appliance, and provides a control command corresponding to the menu to the appliance when the menu is selected from the menus. The appliance receives the control command, and detects and executes an internal command according to the selected menu.

This application claims the benefit of the Korean Application No. P2001-062879 filed on Oct. 12, 2001, which is hereby incorporated by reference.

### BACKGROUND OF THE INVENTION

1. Field of the Invention

The present invention relates to a user interface method and apparatus, and more particularly, to a user interface method and apparatus for an appliance connected with a host system.

2. Discussion of the Related Art

Generally, household or office appliances are implemented to communicate with a host system such as a computer, a user can embody a variety of services such as the update of programs of the appliances through the host system.

For this, the host system is provided with a separated control program for controlling the appliances. The control program provides an interface between the user of the host system and the appliance.

However, since the user interface provided by the control program of the host system is different from the user interface which is already embodied in the appliance, the user should newly learn how to use the user interface.

As described above, since it is very inconvenient to newly learn how to use the user interface provided by the host system, the user does not will to use the user interface regardless of controlling the appliance through the host system.

### SUMMARY OF THE INVENTION

Accordingly, the present invention is directed to a user interface method and apparatus for an appliance connected with a host system that substantially obviates one or more problems due to limitations and disadvantages of the related art.

An object of the present invention is to provide a user interface method and apparatus for an appliance connected with a host system.

Additional advantages, objects, and features of the invention will be set forth in part in the description which follows and in part will become apparent to those having ordinary skill in the art upon examination of the following or may be learned from practice of the invention. The objectives and other advantages of the invention may be implemented and attained by the structure particularly pointed out in the written description and claims hereof as well as the appended drawings.

To achieve these objects and other advantages and in accordance with the purpose of the invention, as embodied and broadly described herein, the present invention provides a user interface method for an appliance connected to a host system including the steps of a) the host computer displaying menus having a structure identical with a structure of menus implemented in the appliance, b) providing a control command corresponding to the menu to the appliance when the menu is selected from the menus, and c) the appliance receiving the control command, and detecting and executing an internal command according to the selected menu.

In another aspect of the present invention, there is provided a user interface apparatus for an appliance connected to a host system including a memory for storing information for displaying a virtual input device having a button structure corresponding to a button structure of an input device which is implemented in the appliance and information indicating each button, a display for displaying the virtual input device, a user interface for providing an interface between the host system and the user, an interface section for providing an interface between the host system and the appliance, and a control section for displaying the virtual input device on the display, generating a control command including an information indicating a selected button when the selected button is one of buttons of the virtual input device displayed through the user interface and is selected, and transmitting the control command to the appliance through the user interface.

In still another aspect of the present invention there is provided a user interface apparatus for an appliance connected to a host system including an interface section for providing an interface between the host system and the appliance, a memory for storing information for extracting an internal command corresponding to a control command provided from the host system, and a control section for extracting and executing an internal command corresponding to the control command when the control command is provided through the interface section.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a schematic menu structure of a conventional video display appliance;

FIG. 2 illustrates a structure of a system being applicable by a first and second preferred embodiments of the present invention;

FIGS. 3 and 4 are flowcharts illustrating interface procedures according to the first preferred embodiment of the present invention;

FIGS. 5 and 6 illustrate examples of menu according to the first preferred embodiment of the present invention;

FIGS. 7 and 8 are flowcharts illustrating processing procedures according to the second preferred embodiment of the present invention; and

FIG. 9 illustrates an example of a virtual input device according to the second preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Though the present invention is applicable to all appliances that are connected with a host system, the detailed description of the present invention will be done with an example of video display appliance connected with a computer for the purpose of presentation.

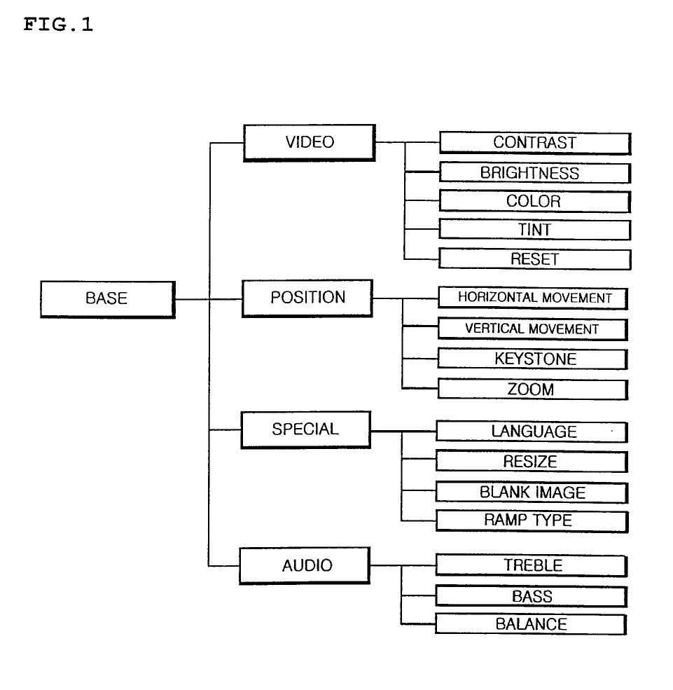

Generally, the menu of the video display appliance includes a hierarchy structure that a plurality of parent menus have more than at least one child menu. The menu of the video display appliance having the hierarchy structure is illustrated in FIG. 1, by referring FIG. 1, a video menu includes a child menu consisting of a contrast, a brightness, a color, a tint, and a reset, a position menu includes a child menu consisting of a flip horizontal, a flip vertical, a keystone, and a zoom, a special menu includes a child menu consisting of a language, a resize, a blank image, a lamp time, and an audio menu includes a child menu consisting of a treble, a bass, and a balance.

There are two user interfaces, a control keypad and a remote controller of the video display appliance having the hierarchy structure.

According to the first preferred embodiment of the present invention, a computer controlling the video display appliance is provided with a menu having a structure identical to the menu structure of the video display appliance. The second preferred embodiment of the present invention provides to the computer controlling the video display appliance a virtual input device having a configuration and function identical to a configuration of the control keypad and the remote controller. According to the first and second embodiments of the present invention, the computer user can control the video display appliance by means of the menu or the virtual input device having structure or configuration identical to the interface of the video display appliance.

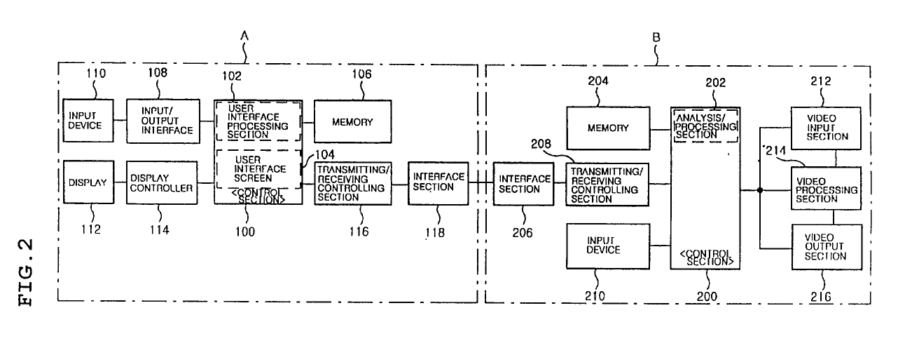

As shown in FIG. 2 illustrating the structure of the system applicable by the first and second preferred embodiments of the present invention, the system generally includes a computer A and a video display appliance B.

A control section 100 of the computer A includes a user interface processing section 102 for providing a user interface according to the first or second preferred embodiment of the present invention, and a user interface screen section 104. The user interface processing section 102 interprets and processes information inputted through an input device 110 by the user, and transmits the processed information as a first and second controlling commands to the video display appliance B through a transmitting and receiving control section 116 and an interface section 118. The transmitting and receiving control section 116, according to request from the user interface processing section 102, transmits various information to the video display appliance B in accordance with a communication protocol, or provides a performance result of the first or the second controlling command fed back from the video display appliance B to the user interface screen 104. The user interface screen 104 displays the menu or the virtual input device of the first and second preferred embodiments of the present invention on the display 112 simultaneously with the performance result of the first and second controlling commands provided from the video display appliance B on the display 112. A memory 106 stores an execute program of the control section 100, various information, a description of the menu structure, and a description for operation. An input-output interface 108 interfaces between the control section 100 and an input device 110. The input device 110 provides the control section 100 information and commands inputted by the user. A display controller 114 displays a variety of information on the display 112 by control of the control section 100, more especially, displays the menu or the virtual input device of the first and second preferred embodiment on the display 112.

Moreover, a control section 200 of the video display appliance B controls the video display appliance B overall, and includes an analysis/processing section 202 for providing the user interface according to the first and second preferred embodiments of the present invention. The analysis/processing section 202 converts the first or the second controlling command provided from a transmitting and receiving control section 208 into a command within the video display appliance B, and transmits the result of the conversion to the computer B through a transmitting and receiving control section 208 and an interface 206. A memory 204 a processing program of the control section 200, a variety of information, and the first and second commands. An input device 210 interfaces between the user and the control section 200. The video display appliance B includes a video input section 212 for executing an inherent function, a video processing section 214, and a video output section 216.

The interface between the computer A and the video display appliance B can be implemented by various way such as a serial communication, a wireless communication, and an infrared communication.

First, the first preferred embodiment of the present invention, which is applicable to the system as describe above, will be described in detail.

The compute A includes a structure of the menu according to the first preferred embodiment and a description of the menu structure. The description can schematically describe the menu structure for the purpose of guaranteeing the structural uniformity with the user interface implemented in the video display appliance B.

The description of the menu structure is comprised of information about the each menu. The information includes a name, a hierarchy level, an order in a corresponding level, a parent menu, a number of a child menu, and identification information of an operation linked to the corresponding menu.

The hierarchy level of the menu represents a level where a corresponding menu locates in a menu structure, and the order in the corresponding level indicates the order of the corresponding menu in the corresponding level. The parent menu indicates an upper menu which the corresponding menu is dependent from, the number of the child menu indicates numbers of a submenu dependent from the corresponding menu. The operation identification information of an operation linked to the corresponding menu is information for identifying the operation linked to a present menu.

An example of the description of the menu structure is shown below.

Name: Menu Base

Hierarchy level: 0 (zero) (Base Level)

Parent menu: None

Order: 1 (one)

No. of the child menu: 4

Id information of operation: None (Base Level Parent)

Name: Video Main Menu

Hierarchy level: 1 (one) (Top Level)

Parent menu: Menu Base

Order: 1 (one)

No. of the child menu: 5

Id information of operation: None (Top Level Parent)

Name: Video Contrast Base

Hierarchy level: 2 (1st children)

Parent menu: Video Main Menu

Order: 1 (one)

No. of the child menu: 0 (zero)

ID information of operation: Video contrast

The computer A includes an operation description for providing the operational relationship between the computer A and the video display appliance B.

The operation description includes an operation name, an operation number, an operation type, a parameter, a manipulation range, and a control code as information about each operation.

The operation type represents a mode of performance of the operation. In the mode of the performance of the operation, there are a gage mode, an execution mode, and a selection mode. The parameter indicates a parameter for an operation require with the parameter. The manipulation range indicates variable range of th parameter with respect to the corresponding operation when the operation is the gage mode or the selection mode. The control code is identical with a control code used in the control section of the video display appliance.

An example of the operation description is shown below.

Operation name: contrast

Operation type: Gage

Parameter: Contrast number

Manipulation range: [0, 100]

Control code: 10

Operation name: Brightness

Operation type: Gage

Parameter: Brightness Number

Manipulation range: [0, 100]

Control code: 11

Moreover, a first command list stored in the memory 204 of the video display appliance B includes a command identification information, a control code, and a type, and used in analysis of the first control command in the video display appliance B.

An example of the first command list is shown in Table 1.

TABLE 1

| Order | Operation | Control Code | Type |
|---|---|---|---|
| 1 | Contrast | 10 | 1 |
| 2 | Brightness | 11 | 1 |
| 3 | Color | 12 | 1 |
| . . . | . . . | . . . | . . . |

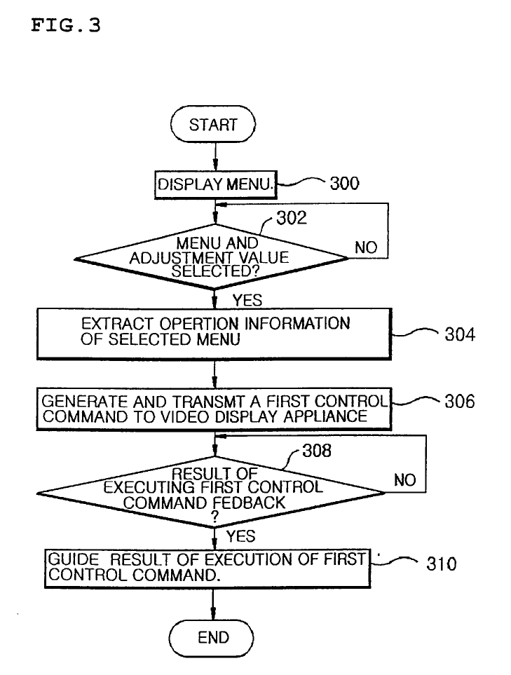

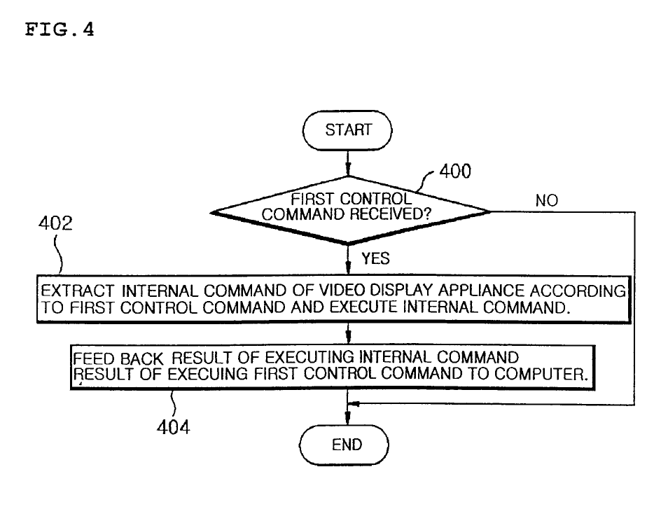

Now, the user interface method using the description of the menu structure and the first command list according to the first preferred embodiment of the present invention by referring FIGS. 3 through 6.

According to the first preferred embodiment, the control section 100 of the computer A displays a menu of a structure identical with the menu structure provided to the video display sequence B on the display 112 (Step 300).

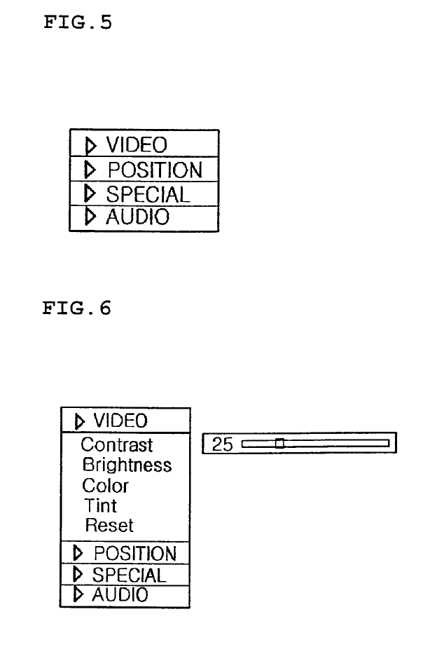

Here, by referring FIG. 5 showing an example of the menu provided by the control section 100 of the computer A, the manipulation procedures of the menu are described. When the user selects a video menu from the most upper menu consisting of the video menu, a position menu, a special menu, and an audio menu, the control section 100 displays a submenu of the video menu. The submenu of the video menu includes a contrast, a brightness, a color, a tint, and a reset. When the user selects the contrast of an increase-and-decrease type item among the submenus, the control section 100 displays a BAR for increasing or decreasing the contrast so that the adjusting range can be guide through the BAR. If the user manipulates the BAR, the control section 100 detects an adjusting value of the contrast corresponding to the manipulation position. By using this way, the user can select all menus and the adjusting value.

If the user selects the menu and the adjusting value (Step 302), the control section 100 reads the information for the selected menu from the description of the menu structure stored in the memory 106. After reading the information of the selected menu, the control section 100 reads the information of the operation corresponding to the selected menu from the operation description stored in the memory 106 by using the operation identification information contained to the read information (Step 304). After this, the control section 100 generates the first control command by using the information for the operation and the adjusting value and transmits the first control command to the video display appliance B (Step 306). Here, the first control command includes a user interface type, a control code, an operation type, and an adjusting value.

For example, if the user commands to adjust the value of the contrast to 10 (ten) through the menu according to the first preferred embodiment of the present invention, the first control command becomes code “10010110”. The “100” from the code indicates a user interface type, the “10” indicates a control code of the contrast, the code “1” indicates the increase-and-decrease type of the operation type with respect to the contrast, and the code “10” of the adjusting value.

As described above, after transmission of the first control command to the video display appliance B, the control section 100 checks whether the performance result of the control command is fed back from the video display appliance B (Step 308). The control section 100 guides the result of the feedback when the performance result of the first control command is fed back.

Meanwhile, when the control command is received through the interface section 206 and the transmitting and receiving control section 208, the control section 200 of the video display appliance A searches whether the received control command is the first control command or not by confirming whether a first three numbers of the first control command are 100 (Step 400). The control section 100 extracts a control code contained in the first control command when the received control command is the first control command. After this, the control section 200 extracts an internal command of the video display appliance corresponding the control code from the first command list stored in the memory 204, and executes the extracted internal command (Step 402). After execution of the extracted internal command, the control section 200 feeds back the result of the execution of the operation to the computer A as a result of execution of the first control command (Step 404).

Like this, according to the first preferred embodiment of the present invention, by providing a menu having a structure identical with a menu structure of the video display appliance B through the computer A for controlling the video display appliance B, the user of the computer A can control the video display appliance B without a specific practice.

Now, the second preferred embodiment of the present invention capable of being applied to the system will be described in detail.

According to the second preferred embodiment of the present invention, the computer A provides a virtual input device similar to an input device used in the video display appliance B by using the description of the command code used in the video display appliance B.

The description of the command code includes a button name of each button, an input device type, a command name, a command order, and a control code. The virtual input device type indicates kinds of the virtual input devices, the command name indicates the name of the button displayed on the virtual input device, the command order indicates the order which a corresponding button is located on the virtual input device, and the control code indicates a control code to be transmitted to the video display appliance B when the corresponding button is selected in the virtual input device.

An example of the description of the command code list follows below.

Button name: MENU button

Virtual input device type: Remote controller

Command name: MENU

Command order: 1

Control code: 15

Button name: ENTER button

Virtual input device type: Remote controller

Command name: ENTER

Command order: 2

Control code: 44

Button name: UP button

Virtual input device type: Remote controller

Command name: UP

Command order: 3

Control code: 1

Button name: DOWN button

Virtual input device type: Remote controller

Command name: DOWN

Command order: 4

Control code: 2

The second command list includes command identification information and a control code. The second command list is stored in the memory 204 of the video display appliance B and is used to interpret the second control command.

An example of the second command list is shown in Table 2.

TABLE 2

| Order | Command identification information | Control code |
|---|---|---|
| 1 | MENU | 15 |
| 2 | ENTER | 44 |
| 3 | UP | 1 |

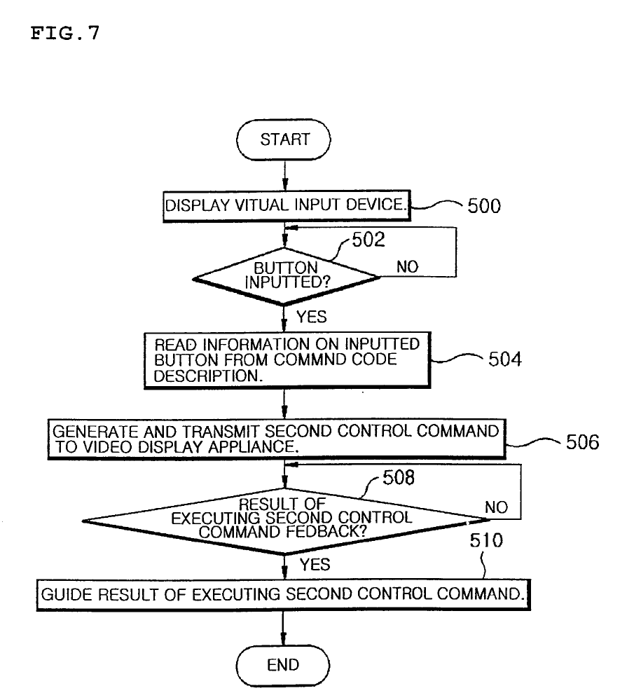

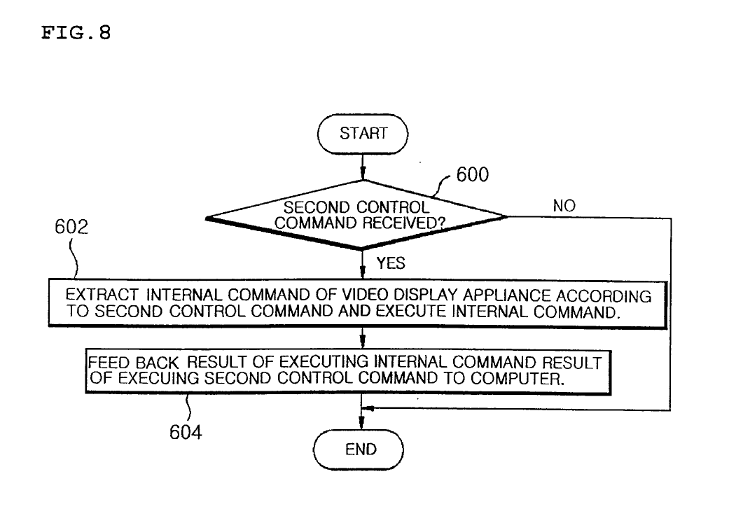

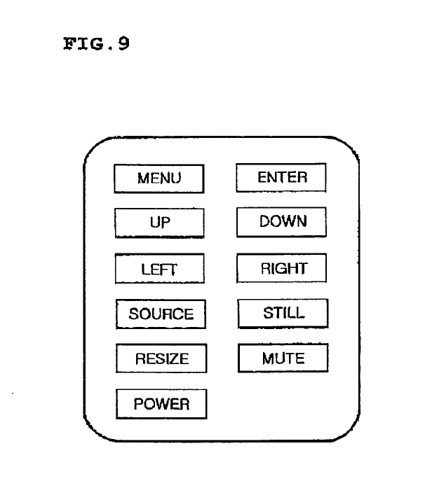

Now, the user interface method according the second preferred embodiment of the present invention will be described in detail by referring FIGS. 7 through 9. The user interface method uses the description of the command code and the second command list.

According to the second preferred embodiment of the present invention, the control section 100 of the computer A displays the virtual input device having a configuration similar to the input device provided to the video display appliance B on the display 112 (Step 500).

Here, as shown in FIG. 5 illustrating an example of the virtual input device provided by the control section of the computer A, the virtual input device includes a plurality of buttons. The button includes a MENU, an ENTER, an UP, a LEFT, a RIGHT, a SOURCE, a STILL, a RESIZE, a MUTE, and POWER, and the user selectively inputs the button so as to input his/her desired command.

When the user inputs one of the plurality of buttons provided to the virtual input device (Step 502), the control section 100 reads the information of the inputted button from the description of the command code stored in the memory 106 (Step 504). The control section 100 extracts a control code corresponding to the inputted button from the extracted information, and generates a second control command by using the extracted control code. Here, the second control command includes identification information indicating a user interface of the second preferred embodiment of the present invention and the control code. For example, when the user inputs the UP button, the second control command becomes “2001” being combination of the interface identification information “200” and the control code “1” corresponding to the UP button.

As described above, when the second control command is generated, the control section 100 transmits the second control command to the video display appliance B (Step 506). After the transmission of the second control command, the control section 100 checks whether execution result of the second control command is fed back from the video display appliance B (Step 508). If the execution result of the second control command is fed back, the control section 100 guides the result of the feedback on the display 112.

Meanwhile, the control section 200 of the video display appliance B searches whether a received control command is the second control command or not by confirming that the first three numbers of the control command is 200 when the control command is received through the interfacing section 206 and the transmitting-and-receiving control section 208 (Step 600). The control section 100 extracts a control code contained to the second control command when the received control command is the second control command. After this, the control section 200 extracts the internal command of the video display appliance B corresponding to the extracted control code from the second command list stored in the memory 204, and executes the extracted internal command (Step 602).

The execution of the extracted internal command is finished, the control section 200 transmits the execution result of the internal command of the video display appliance B as the execution result of the second control command to the computer A.

As described above, according to the second preferred embodiment of the present invention, by providing a virtual input device similar to the input device provided to the video display appliance B through the computer A controlling the video display appliance B, the user of the computer A can easily control the video display appliance B without a special practice.

As described above, according to the present invention, the video display appliance can be easily controlled by a menu or a virtual input device whose a configuration and structure identical with an interface provided to devices connected to a host system, so that a user can easily control the devices connected to the host system without hesitation.

It will be apparent to those skilled in the art than various modifications and variations can be made in the present invention. Thus, it is intended that the present invention covers the modifications and variations of this invention provided they come within the scope of the appended claims and their equivalents.

What is claimed is:

1. A user interface method for an appliance connected to a host system, comprising the steps of:
a) the host computer displaying menus having a structure identical with a structure of menus implemented in the appliance;
b) providing a control command corresponding to the menu to the appliance when the menu is selected from the menus; and
c) the appliance receiving the control command, and detecting and executing an internal command according to the selected menu.

2. A user interface method for an appliance connected to a host system, comprising the steps of:
a) the host system displaying a virtual input device having a button structure corresponding to a button structure of an input device provided in the appliance;
b) providing a control command corresponding to an inputted button of the displayed virtual input device to the appliance when the inputted button is inputted; and
c) the appliance receiving the control command, and detecting and executing an internal command according to the inputted button.

3. The method as claimed in claim 1, further comprising the step of d) the appliance feeding a result of executing the internal command back to the host system when the execution of the internal command is finished.

4. The method as claimed in claim 1, further comprising the step of: e) the host computer guiding the result of executing the internal command fed back.

5. The method as claimed in claim 1, wherein the control command includes an adjustment value when the adjust value is selected for selection of the menu.

6. A user interface apparatus for an appliance connected to a host system comprising:
a memory for storing information for displaying a menu having a structure identical with a structure of a menu which is implemented in the appliance and information indicating each menu;
a display for displaying the menu having the structure identical with the structure of the menu which is implemented in the appliance;
a user interface for providing an interface between the host system and the user;
an interface section for providing an interface between the host system and the appliance; and
a control section for displaying the menu having the structure identical with the structure of the menu which is implemented in the appliance, generating a control command including information indicating a certain menu when the certain menu is one of menus displayed through the user interface and is selected, and transmitting the control command to the appliance through the user interface.

7. A user interface apparatus for an appliance connected to a host system comprising:
a memory for storing information for displaying a virtual input device having a button structure corresponding to a button structure of an input device which is implemented in the appliance, and information indicating each button;
a display for displaying the virtual input device;
a user interface for providing an interface between the host system and the user;
an interface section for providing an interface between the host system and the appliance; and
a control section for displaying the virtual input device on the display, generating a control command including information indicating a selected button when the selected button is one of buttons of the virtual input device displayed through the user interface and is selected, and transmitting the control command to the appliance through the user interface.

8. The apparatus as claimed in claim 6, wherein the control command comprises at least one of an interface type and an adjust value.

9. The apparatus as claimed in claim 6, wherein the control section guides a result of the execution of the internal command through the display when the result of executing the internal command is provided from the appliance.

10. A user interface apparatus for an appliance connected to a host system comprising:
an interface section for providing an interface between the host system and the appliance;
a memory for storing information for extracting an internal command corresponding to a control command provided from the host system; and
a control section for extracting and executing the internal command corresponding to the control command when the control command is provided through the interface section.

11. The apparatus as claimed in claim 10, wherein the control section transmits a result of executing the internal command to the host system.
